(19) United States
(12) Patent Application Publication
(10) Pub. No.: US 2006/0061271 A1
(43) Pub. Date: Mar. 23, 2006

(54) Display panel and method of manufacturing the same

(75) Inventors: Toru Futagami, Maiduru-shi (JP); Koichi Sakaguchi, Toyonaka-shi (JP)

Correspondence Address: COHEN, PONTANI, LIEBERMAN & PAVANE, Suite 1210, 551 Fifth Avenue, New York, NY, 10176, US

(73) Assignee: Nippon Sheet Glass Company, Limited, Tokyo (JP)

(21) Appl. No.: 11/222,568

(22) Filed: Sep. 9, 2005

Related U.S. Application Data
(63) Continuation of application No. PCT/JP04/03093, filed on Oct. 3, 2004.

(30) Foreign Application Priority Data
Mar. 10, 2003 (JP) 2003-063220
Sep. 9, 2003 (JP) 2003-317114
Sep. 9, 2003 (JP) 2003-328805
Dec. 19, 2003 (JP) 2003-422679

(51) Int. Cl. H01J 1/62

(52) U.S. Cl. 313/509

(57) ABSTRACT

A display panel according to which exposure to a high temperature during manufacture can be prevented, and the weather resistance can be improved. An organic EL device 100 as the display panel is comprised of an alkali-free glass substrate 10, an organic EL laminated body 20 formed on the substrate 10, and a sealing plate 30 formed so as to cover the organic EL laminated body 20. The sealing plate 30 has formed thereon a 2.0 mm-wide peripheral projecting portion 31 around the periphery of a central recessed portion 32. The organic EL laminated body 20 is formed on the substrate 10, and is comprised of a conductive film 21 composed of an ITO film, an organic EL multilayer film 22 formed on an upper surface of the conductive film 21, upper transparent electrodes 23 formed on an upper surface of the organic EL multilayer film 22, and lead-out electrodes 24 connected to the upper transparent electrodes 23. The substrate 10, and the peripheral projecting portion 31 of the sealing plate 30 are sealed together through a welded layer 40 comprised of a solder disposed at a sealing portion formed between the substrate 10 and the peripheral projecting portion 31 of the sealing plate 30.

### TECHNICAL FIELD

The present invention relates to a display panel, and a method of manufacturing the same.

### BACKGROUND ART

Among conventional display panels, in particular two types of EL (electroluminescent) device are known as EL display panels, a passive type one suitable for matrix display according to which a light-emitting layer can be caused to emit light selectively by selectively applying voltages between electrodes and back electrodes that face one another with the light-emitting layer therebetween, and an active type one suitable for moving image display according to which high-speed switched display can be carried out through a high-speed switching function.

For a passive type EL device as described above, a simple matrix structure is adopted; the EL device is comprised of a substrate, electrodes disposed on the substrate, an EL laminated body that contains a light-emitting layer and is formed on an upper surface of the electrodes, back electrodes that are formed on an upper surface of the EL laminated body, and a glass sealing plate that has a central portion thereof processed into a recessed shape so as to define at a periphery of the sealing plate a peripheral projecting portion a top surface of which is bonded to the substrate having the EL laminated body formed thereon, and is bonded onto the substrate via a sealing portion on the top surface of the peripheral projecting portion.

Moreover, for an active type EL device as described above, an active matrix structure is adopted; similar to the structure of a TFT liquid crystal device, the EL device is comprised of a substrate, a thin-film transistor circuit or a diode formed for each pixel on the substrate, an EL laminated body that contains a light-emitting layer and is formed on an upper surface of the thin-film transistor circuits or diodes, and a glass sealing plate that has a central portion thereof processed into a recessed shape so as to define at a periphery of the sealing plate a peripheral projecting portion a top surface of which is bonded to the substrate having the EL laminated body formed thereon.

For the above passive type EL device and active type EL device, in a top emission type EL device, members from the light-emitting layer to the sealing plate side are made of transparent materials, whereby light from the light-emitting layer can be made to exit from the sealing plate side.

With such EL devices, upon long-term use, the sealing ability of the sealing plate may drop, and hence moisture or the like may get into the EL device, resulting in deterioration of the EL multilayer film. To prevent this, the substrate and the sealing plate are bonded together via a bonding layer comprised of an adhesive disposed at the sealing portion between the substrate and the peripheral projecting portion of the sealing plate so as to block off the inside of the EL device from moisture and oxygen. A resin, a low-melting-point glass, or the like is generally used as the material of the adhesive forming the bonding layer. (See, for example, Japanese Laid-open Patent Publication (Kokai) No. 2002-231442).

However, among display panels, for EL devices (i.e. EL display panels) in particular, in the case that a resin adhesive is used as the material of the bonding layer disposed at the sealing portion between the substrate and the peripheral projecting portion of the sealing plate, there is a problem that the resin is moisture-permeable, and hence moisture infiltrates into the EL device through the resin, whereby the properties of the EL device deteriorate (particularly in the case of an organic EL device), and the weather resistance drops. Moreover, in the case of using a low-melting-point glass as the material of the bonding layer, there is a problem that the EL device is heated to a high temperature during the bonding process, whereby the properties of the EL device deteriorate (particularly in the case of an organic EL device), and warping of the substrate in the EL device occurs.

It is an object of the present invention to provide a display panel according to which exposure to a high temperature during manufacture can be prevented, and the weather resistance can be improved.

### DISCLOSURE OF THE INVENTION

To attain the above object, in a first aspect of the present invention, there is provided a display panel comprising a substrate, and a sealing plate sealed onto the substrate, the display panel characterized in that the substrate and the sealing plate are sealed together via a welded layer comprising a metallic material.

According to the first aspect of the present invention, the substrate and the sealing plate are sealed together via a welded layer comprising a metallic material. As a result, the display panel can be prevented from being exposed to a high temperature during manufacture, and moreover the gas-tightness of a recessed portion of the sealing plate can be improved and the moisture permeability of the recessed portion can be reduced, and hence the weather resistance of the display panel can be improved.

Preferably, the metallic material comprises a solder containing at least one material selected from the group consisting of Sn, Cu, In, Bi, Zn, Pb, Sb, Ga, and Ag.

Preferably, the solder further contains at least one material selected from the group consisting of Ti, Al, and Cr.

According to this construction, the solder further contains at least one material selected from the group consisting of Ti, Al, and Cr. As a result, the adhesion between the welded layer and glass components of the substrate can be improved.

More preferably, the metallic material has a eutectic point or melting point of not more than 250° C.

According to this construction, the metallic material has a eutectic point or melting point of not more than 250° C. As a result, deterioration of the display panel through heat during welding, and warping of the substrate through heat can be reliably prevented.

More preferably, the solder substantially comprises In and Sn, and has a liquidus temperature of not more than 150° C.

According to this construction, the solder substantially comprises In and Sn, and has a liquidus temperature of not more than 150° C. As a result, the adhesion to the substrate can be further improved, and moreover the sealing can be accomplished at a low temperature.

More preferably, the solder substantially comprises In and Sn, has an In/(In+Sn) weight distribution ratio in a range of 50 to 65%, and has a liquidus temperature of not more than 125° C.

According to this construction, the solder substantially comprises In and Sn, has an In/(In+Sn) weight distribution ratio in a range of 50 to 65%, and has a liquidus temperature of not more than 125° C. As a result, the adhesion to the substrate can be further improved, and furthermore the structure after solidification is fine and highly flexible, and the mechanical properties are excellent, and moreover the sealing can be accomplished at a yet lower temperature.

Further preferably, the solder substantially comprises In, Sn, Zn and Ti, has an In/(In+Sn) weight distribution ratio in a range of 50 to 65%, has a Zn content in a range of 0.1 to 7.0%, has a Ti content in a range of 0.0001 to 0.1%, and has a liquidus temperature of not more than 150° C.

According to this construction, the solder substantially comprises In, Sn, Zn and Ti, has an In/(In+Sn) weight distribution ratio in a range of 50 to 65%, has a Zn content in a range of 0.1 to 7.0%, has a Ti content in a range of 0.0001 to 0.1%, and has a liquidus temperature of not more than 150° C. As a result, the adhesion to the substrate can be further improved, and the Ti can be contained more homogeneously due to making both Ti and Zn be present, and hence the weather resistance at the interface between the solder and the substrate can be improved.

Further preferably, the solder substantially comprises In, Sn, Zn and Ti, has an In/(In+Sn) weight distribution ratio in a range of 50 to 65%, has a Zn content in a range of 0.1 to 5.0%, has a Ti content in a range of 0.0001 to 0.05%, and has a liquidus temperature of not more than 125° C.

According to this construction, the solder substantially comprises In, Sn, Zn and Ti, has an In/(In+Sn) weight distribution ratio in a range of 50 to 65%, has a Zn content in a range of 0.1 to 5.0%, has a Ti content in a range of 0.0001 to 0.05%, and has a liquidus temperature of not more than 125° C. As a result, the adhesion to the substrate can be further improved, and the Ti can be contained more homogeneously due to making both Ti and Zn be present, and hence the weather resistance at the interface between the solder and the substrate can be further improved.

Further preferably, the display panel is an organic EL display panel.

To attain the above object, in a second aspect of the present invention, there is provided a method of manufacturing a display panel comprising a substrate, and a sealing plate sealed onto the substrate, characterized by sealing together the substrate and the sealing plate through friction welding using a molten metallic material.

According to the second aspect of the present invention, the substrate and the sealing plate are sealed together through friction welding using a molten metallic material. As a result, the sealing can be accomplished with improved adhesion of the metallic material to the substrate.

To attain the above object, in a third aspect of the present invention, there is provided a method of manufacturing a display panel comprising a substrate, and a sealing plate sealed onto the substrate, characterized by comprising an application step of applying a molten metallic material onto at least one of an outer peripheral portion of one major surface of the substrate and an outer peripheral portion of one major surface of the sealing plate, a placing-together step of placing the one major surface of the substrate and the one major surface of the sealing plate together, and a sealing step of welding the applied metallic material so as to seal the substrate and the sealing plate together.

According to the third aspect of the present invention, a molten metallic material is applied onto at least one of an outer peripheral portion of one major surface of the substrate and an outer peripheral portion of one major surface of the sealing plate, the one major surface of the substrate and the one major surface of the sealing plate are placed together, and the applied metallic material is welded so as to seal the substrate and the sealing plate together. As a result, the metallic material can be applied to a desired width and thickness, and hence the weather resistance of the display panel can be further improved.

Preferably, in the application step, when applying the metallic material, an interface between the molten metallic material and the at least one of the outer peripheral portion of the one major surface of the substrate and the outer peripheral portion of the one major surface of the sealing plate is activated.

According to this construction, when applying the metallic material, an interface between the molten metallic material and the at least one of the outer peripheral portion of the one major surface of the substrate and the outer peripheral portion of the one major surface of the sealing plate is activated. As a result, the bonding strength between the substrate and the metallic material and the bonding strength between the sealing plate and the metallic material can be improved.

Further preferably, at least one of the application step and the sealing step is carried out in an inert atmosphere.

According to this construction, at least one of the application and the sealing is carried out in an inert atmosphere. As a result, production of an oxide on the surface of the metallic material can be suppressed.

### BRIEF DESCRIPTION OF THE DRAWINGS

FIG. 1 is a sectional view of an EL display panel which is a display panel according to an embodiment of the present invention;

FIG. 2 is a sectional view of a welding apparatus that welds together a substrate and a peripheral projecting portion of a sealing plate appearing in FIG. 1;

FIG. 3 is a view showing a variation of an introducing plate appearing in FIG. 2;

FIGS. 4A, 4B and 4C are partial sectional views showing variations of the organic EL device shown in FIG. 1; specifically, FIG. 4A shows a case in which an outer peripheral portion of each of the substrate and the sealing plate is stepped, FIG. 4B shows a case in which the outer peripheral portion of each of the substrate and the sealing plate is beveled, and FIG. 4C shows a case in which an outer frame is welded to an outer peripheral edge of each of the substrate and the sealing plate using a solder;

FIGS. 5A, 5B and 5C are views useful in explaining a variation of a method of manufacturing a display panel according to an embodiment of the present invention; and

FIG. 6 is a view useful in explaining the variation of the method of manufacturing the display panel according to the embodiment of the present invention.

### BEST MODE FOR CARRYING OUT THE INVENTION

Embodiments of the present invention will now be described with reference to the drawings.

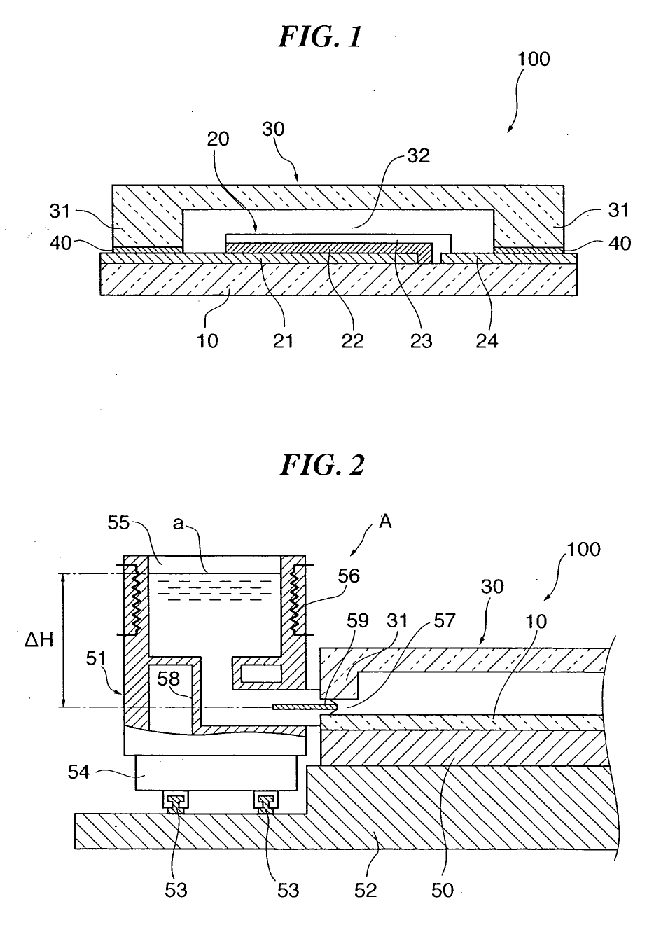

FIG. 1 is a sectional view of an EL display panel which is a display panel according to an embodiment of the present invention.

As shown in FIG. 1, a top emission type organic EL device 100, which is the EL display panel, has a passive structure, and is comprised of a transparent plate-shaped alkali-free glass substrate 10 of size 7.0 cm square by 1.0 mm thick, an organic EL laminated body 20 formed on the substrate 10, and a sealing plate 30 formed so as to cover the organic EL laminated body 20.

The sealing plate 30 is processed from a transparent plate-shaped alkali-free glass starting material glass plate of size 5.0 cm square by 1.1 mm thick, and has formed on a surface thereof, a 2.0 mm-wide peripheral projecting portion 31 around the periphery of a central recessed portion 32 so as to define a central portion of the sealing plate 30 into a recessed shape; the thickness of a base portion of the sealing plate 30 is 0.8 mm.

The recessed portion 32 of the sealing plate 30 is formed by carrying out wet etching, described below, on the starting material glass plate so as to form the starting material glass plate into a recessed shape. The etching depth of the starting material glass plate etched by such wet etching was measured to be 300 μm. Moreover, corner portions of a base surface of the recessed portion 32 were curved, the radius of curvature being approximately 300 μm. The thickness of the base portion in the recessed portion 32 of the sealing plate 30 is preferably in a range of 0.3 to 1.1 mm. At a thickness of less than 0.3 mm, the strength of the sealing plate 30 will be insufficient, whereas at 1.1 mm, a sufficient strength will be obtained for the sealing plate 30.

In the wet etching, the starting material glass plate is masked with acid-resistant tape, i.e. a resist, such that a 4.5 cm-square central portion of the starting material glass plate remains exposed, and then the masked starting material glass plate is immersed, for example, in an etching liquid held at 25° C. comprised of a mixed liquid of 20 mass % of hydrofluoric acid and 1 mass % of sodium dodecylbenzene sulfonate.

The organic EL laminated body 20 is formed on the substrate 10, and is comprised of a conductive film 21 composed of a 300 nm-thick ITO film, an organic EL multilayer film 22 that contains a light-emitting layer, described below, and is formed on an upper surface of the conductive film 21, upper transparent electrodes 23 composed of a 500 nm-thick ITO film that is formed on an upper surface of the organic EL multilayer film 22, and lead-out electrodes 24 composed of a 300 nm-thick ITO film that is connected to the upper transparent electrodes 23.

The organic EL multilayer film 22 is comprised of a hole transport layer of height 70 nm that is made of triphenyl diamine and is disposed on the conductive film 21 side, and a light-emitting layer of height 70 nm that is made of a quinolinol aluminum complex and is formed on an upper surface of the hole transport layer. Furthermore, a structure may be adopted in which a transparent electron transport layer made of a triazole or an oxadiazole is further disposed between the upper transparent electrodes 23 and the light-emitting layer.

The substrate 10, and the peripheral projecting portion 31 of the sealing plate 30 are sealed together using an apparatus shown in FIG. 2, described below, through a welded layer 40 comprised of a solder disposed at a sealing portion formed between the substrate 10 and the peripheral projecting portion 31 of the sealing plate 30. Specifically, the sealing plate 30 is disposed in a predetermined position relative to the substrate 10, and then the peripheral projecting portion 31 of the sealing plate 30 is welded onto the substrate 10 using a molten solder a of composition 91.2Sn-8.8Zn (eutectic point: 198° C.).

FIG. 2 is a sectional view of the welding apparatus that carries out a method of manufacturing the display panel according to an embodiment of the present invention.

As shown in FIG. 2, the welding apparatus A is constructed as described below so as to be able to seal together the substrate 10 and the peripheral projecting portion 31 of the sealing plate 30 appearing in FIG. 1.

That is, the welding apparatus A has a stepped plate 52; the substrate 10 and the sealing plate 30 of the organic EL device 100 are held oh a high portion of the stepped plate 52 via a stage 50, and a supply tower 51 is held on a low portion of the stepped plate 52. Two rails 53 are disposed on the base portion of the stepped plate 52 so as to extend along the organic EL display panel 100, and the supply tower 51 is placed on a moving mechanism 54 that travels over the rails 53.

The supply tower 51 is comprised of a crucible 55 that has a rectangular cross section and stores a liquid or solid a solder therein, an electric heater 56 that is built into a side wall portion of the crucible 55 and heats the solder a stored in the crucible 55, an introducing portion 58 that has an elongated cross section, communicates with a base portion of the crucible 55, and opens into the sealing portion (a gap 57) between the substrate 10 and the sealing plate 30 of the organic EL device 100, and an introducing plate 59 that is disposed horizontally in the introducing portion 58 at a central level thereof. The introducing plate 59 extends out from the introducing portion 58 and is fitted into the gap 57, whereby the solder a infiltrates into the gap 57 due to the surface tension thereof. In addition, the gravity of a solder at a liquid level ΔH in the crucible 55 is applied to the solder a at the introducing plate 59, whereby infiltration of the solder a into the gap 57 is promoted.

Moreover, the moving mechanism 54 moves over the rails 53 along the gap 57 at a fixed speed. As a result, the solder a infiltrates through the introducing portion 58 into the gap 57 over the entire length of the gap 57.

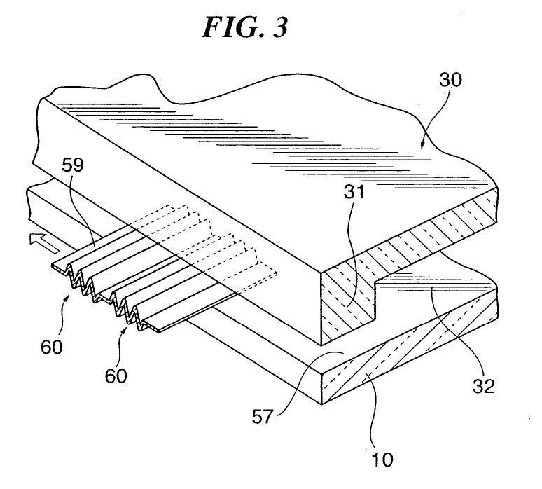

As shown in FIG. 3, the introducing plate 59 may have two series of corrugations 60 extending along the gap 57. The corrugations 60 are such that peaks thereof slide over a top surface of the peripheral projecting portion 31 of the sealing plate 30, and troughs thereof slide over the substrate 10. As a result, the adhesion of the solder a to the substrate 10 can be further improved, and sealing through friction welding can be accomplished.

According to the present embodiment, the substrate 10 and the peripheral projecting portion 31 of the sealing plate 30 are sealed together via the welded layer 40 comprised of the solder a. As a result, the gas-tightness of the recessed portion 32 of the sealing plate 30 can be improved, and moreover the moisture permeability of the recessed portion 32 can be reduced, and hence the weather resistance of the organic EL device 100 can be improved. Moreover, as a result of the above, a desiccant such as silica gel conventionally disposed in the recessed portion 32 of such a sealing plate 30 becomes unnecessary, and hence the manufacturing cost can be reduced, and moreover the number of manufacturing steps can be reduced. Furthermore, the sealing plate 30 can be welded onto the substrate 10 without increasing the temperature of the organic EL device 100. As a result, deterioration of the organic EL device 100 through heat during welding, and warping of the substrate 10 through heat can be prevented.

According to the present embodiment, the substrate 10 and the sealing plate 30 are sealed together by friction welding using the molten solder a. As a result, the sealing can be accomplished with improved adhesion of the solder a to the substrate 10.

In the present embodiment, the welded layer 40 is formed using the welding apparatus A. However, there is no limitation thereto, but rather the welded layer 40 may instead be formed using a joining method such as anodic joining, ultrasonic joining, multi-stage joining, or compression bonding.

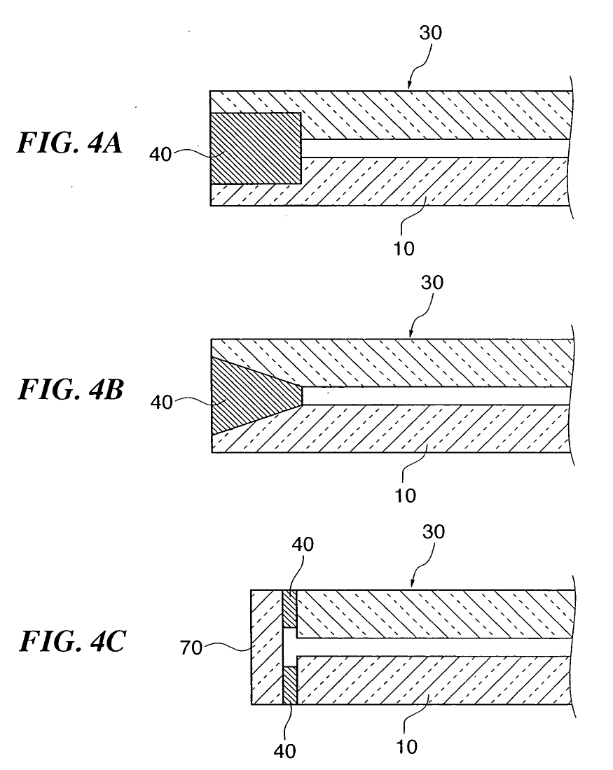

In the present embodiment, the substrate 10 and the peripheral projecting portion 31 of the sealing plate 30 are sealed together through the welded layer 40 comprised of the solder a. However, there is no limitation thereto, but rather as shown in FIG. 4, an outer peripheral portion of each of the substrate 10 and the sealing plate 30 may be stepped (FIG. 4A), or may be beveled (FIG. 4B). Alternatively, as shown in FIG. 4C, at the outer peripheral portion of each of the substrate 10 and the sealing plate 30, the substrate 10 and the sealing plate 30 may be sealed together by welding an outer frame 70 to an outer peripheral edge of each of the substrate 10 and the sealing plate 30 using a welded layer 40 made of the solder a.

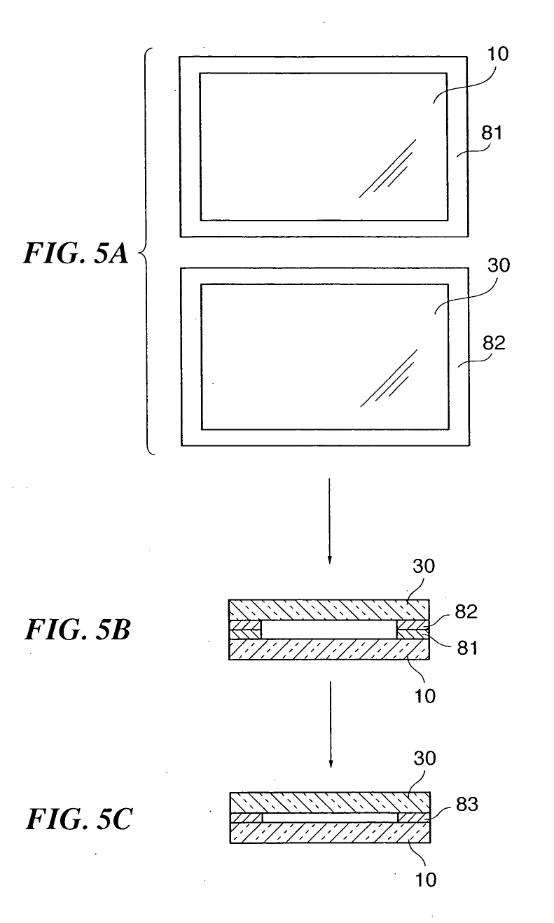

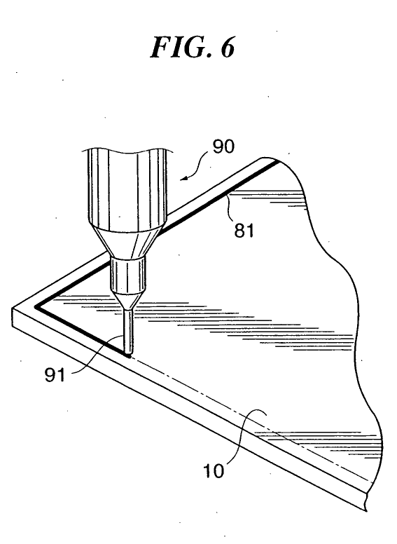

FIGS. 5 and 6 are views useful in explaining a variation of a method of manufacturing a display panel according to an embodiment of the present invention.

In this variation of the method of manufacturing the display panel according to the embodiment of the present invention, first, a transparent plate-shaped alkali-free glass substrate 10 of size 7.0 cm square by 1.0 mm thick, and a sealing plate 30 of the same shape and size as the substrate 10 are prepared, and then, in an inert atmosphere of N₂, Ar or the like, as shown in FIG. 6, using a dispenser 90 having at a tip thereof a tubular ejection opening 91 of inside diameter 1.5 mm and outside diameter 2.0 mm, the tip of the dispenser 90 is slid over one major surface of the substrate 10, thus activating the interface between the substrate 10 and a solder a through friction and applying the molten solder a in a line along an outer peripheral portion of the one major surface of the substrate 10, after which the solder is hardened (application step); a solder portion 81 is thus formed around the whole of the outer peripheral portion of the substrate 10 (FIG. 5C). Furthermore, using the dispenser 90, the interface between the sealing plate 30 and the solder a is activated through friction and the molten solder a is applied in a line along an outer peripheral portion of the one major surface of the sealing plate 30, after which the solder is hardened; a solder portion 82 is thus formed around the whole of the outer peripheral portion of the sealing plate 30.

For the dispenser 90, by controlling the amount of the solder a ejected from the dispenser 90, the width of friction at the interface between the substrate 10 and the solder a, i.e. the outside diameter of the ejection opening 91, and the feed rate of the dispenser 90, solder portions 81 and 82 of a desired width and thickness can be formed.

In the present method, the major surface of the substrate 10 on which the solder portion 81 has been formed and the major surface of the sealing plate 30 on which the solder portion 82 has been formed are then placed together (placing-together step) (FIG. 5B), and then the substrate 10 and the sealing plate 30 are heated to around the eutectic point of the solder a, e.g. 200° C., in an inert atmosphere of N₂, Ar or the like, thus fusing the solder portion 81 and the solder portion 82 together to form a welded layer 83 (FIG. 5C); by thus welding the substrate 10 and the sealing plate 30 together through the welded layer 83, the substrate 10 and the sealing plate 30 are sealed together (sealing step).

According to the present embodiment, the molten solder a is applied onto the outer peripheral portion of one major surface of the substrate 10, and furthermore the molten solder a is applied onto the outer peripheral portion of one major surface of the sealing plate 30, and then the one major surface of the substrate 10 and the one major surface of the sealing plate 30 are placed together, and the solder portion 81 and the solder portion 82 are welded together, thus sealing the substrate 10 and the sealing plate 30 together. As a result, the solder portion 81 and the solder portion 82 can each be made to have a desired width and thickness, and hence the weather resistance of the organic EL device 100 can be further improved.

According to the present embodiment, the interface between the substrate 10 and the solder a and the interface between the sealing plate 30 and the solder a are activated when the molten solder a is applied. As a result, the bonding strength between the substrate 10 and the solder a and the bonding strength between the sealing plate 30 and the solder a can be improved.

According to the present embodiment, at least one of the application and the sealing is carried out in an inert atmosphere of N₂, Ar or the like. As a result, production of an oxide on the surface of each of the solder portion 81 and the solder portion 82 can be suppressed.

In the present embodiment, the tip of the dispenser 90 is slid over the one major surface of the substrate 10, thus activating the interface between the substrate 10 and the solder a through friction when applying the molten solder a. However, there is no limitation to this, but rather the solder a may be vibrated using a vibration generating apparatus, not shown in the drawings, that is linked to the dispenser 90, to generate minute vibrations, thus activating the interface between the one major surface of the substrate 10 and the solder a when applying the solder a onto the one major surface of the substrate 10.

In the present embodiment, the molten solder a is applied onto the outer peripheral portion of one major surface of the substrate 10 and then hardened, and furthermore the molten solder a is applied onto the outer peripheral portion of one major surface of the sealing plate 30 and then hardened. However, there is no limitation to this; the molten solder a may be applied onto at least one of the outer peripheral portion of the one major surface of the substrate 10 and the outer peripheral portion of the one major surface of the sealing plate 30. Specifically, in the case of applying the solder a onto only the outer peripheral portion of the one major surface of the substrate 10, the sealing plate 30 may be vibrated using a vibration generating apparatus, not shown in the drawings, so as to activate the interface between the one major surface of the sealing plate 30 and the solder portion 81, the one major surface of the substrate 10 having the solder portion 81 formed thereon and the one major surface of the sealing plate 30 then being placed together. Similarly, in the case of applying the solder a onto only the outer peripheral portion of the one major surface of the sealing plate 30, the substrate 10 may be vibrated using a vibration generating apparatus, not shown in the drawings, so as to activate the interface between the one major surface of the substrate 10 and the solder portion 82, the one major surface of the sealing plate 30 having the solder portion 82 formed thereon and the one major surface of the substrate 10 then being placed together.

In the embodiments of the present invention, a solder a of composition 91.2Sn-8.8Zn (eutectic point: 198° C.) is used, but there is no limitation thereto. A solder that is an alloy or metal containing at least one material selected from the group consisting of Sn, Cu, In, Bi, Zn, Pb, Sb, Ga, and Ag, and has an eutectic point or melting point of not more than 250° C. may be used.

Furthermore, the above metallic material may further contain at least one material selected from the group consisting of Ti, Al, and Cr. As a result, the adhesion between the welded layer 40 and glass components of the substrate 10 can be improved.

Moreover, it is preferable for the solder to be substantially comprised of In and Sn, and have a liquidus temperature of not more than 150° C. As a result, the adhesion to the substrate 10 can be further improved, and moreover the sealing can be accomplished at a low temperature.

It is more preferable for the solder to be substantially comprised of In and Sn, have In/(In+Sn) in a range of 50 to 65%, and have a liquidus temperature of not more than 125° C. As a result, the adhesion to the substrate 10 can be further improved, and furthermore the structure after solidification is fine and highly flexible, and the mechanical properties are excellent, and moreover the sealing can be accomplished at a yet lower temperature.

Moreover, it is preferable for the solder to be substantially comprised of In, Sn, Zn and Ti, have an In/(In+Sn) weight distribution ratio in a range of 50 to 65%, have a Zn content in a range of 0.1 to 7.0%, have a Ti content in a range of 0.0001 to 0.1%, and have a liquidus temperature of not more than 150° C., and it is more preferable for the solder to have a Zn content in a range of 0.1 to 5.0%, have a Ti content in a range of 0.0001 to 0.05%, and have a liquidus temperature of not more than 125° C. As a result, the adhesion to the substrate 10 can be further improved, and the Ti can be contained more homogeneously due to making both Ti and Zn be present, and hence the weather resistance at the interface between the solder and the substrate 10 can be improved.

Here, in the case that the amount of Zn is less than the above range, the adhesion to the substrate 10 will not be improved, and moreover it will not be possible for the Ti to be contained more homogeneously. On the other hand, in the case that the amount of Zn is greater than the above range, the liquidus temperature of the solder will become high, and hence the temperature required for the bonding will increase, which is inconvenient.

In the case that the amount of Ti is less than the above range, the adhesion to the substrate 10 will not be improved. On the other hand, in the case that the amount of Ti is greater than the above range, the liquidus temperature of the solder will become high, and hence the temperature required for the bonding will increase, which is inconvenient. In particular, compounds between Ti and other components will become prone to precipitate out when the solder is molten, which is undesirable.

Moreover, the closer the solder is to the In—Sn binary system eutectic composition of 52% In and 48% Sn, the better, and in particular a solder having the In—Sn binary system eutectic composition of 52% In and 48% Sn (eutectic point 117° C.) is preferable since the structure after solidification is very fine and highly flexible, and the mechanical properties are excellent.

Furthermore, a solder having the In—Sn binary system eutectic composition of 52% In and 48% Sn (eutectic point 117° C.) with Zn and Ti added thereto, for example a solder having a composition of 51% In, 47% Sn, 2.0% Zn and 0.002% Ti, is preferable. As a result, the adhesion to the substrate 10 will be very good, and the weather resistance at the interface between the solder and the substrate 10 will also be very good.

As the solder, specifically a solder of Sn—Ag type, Sn—Cu type, Sn—Ag—Cu type, Sn—Ag—Bi type, Sn—Ag—Cu—Bi type, or the like may be used, the solder being such as to have a eutectic point of not more than 250° C.

In the present embodiment, wet etching is used as the method of forming the recessed portion 32 in the starting material glass plate, but dry etching may be used, or dry etching and wet etching may be used in combination.

In the present embodiment, an alkali-free glass is used as the material of the sealing plate 30, but, in accordance with the structure of the organic EL device 100, a low-alkali glass, or a soda-lime glass or quartz glass that is subjected to treatment to prevent leaching out of alkali after the etching can be used. Moreover, a metallic material may be used as the material of the sealing plate 30, it being preferable to use Al, Cu or Fe as such a metallic material; SUS, a ceramic, Pt or Au may also be used.

Moreover, the shape of the sealing plate 30 is not limited to the shape shown in FIG. 1, but rather any one enabling sealing to be carried out together with the substrate 10 and the welded layer 40 so as to protect the organic EL laminated body 20 may be used.

In the present embodiment, the organic EL multilayer film 22 has a passive structure, but an active structure may be adopted. Moreover, in the present embodiment, the organic EL device 100 has a top emission structure, but a bottom emission structure may be adopted.

Moreover, the EL multilayer film may be an inorganic EL multilayer film instead of the organic EL multilayer film 22. In this case, one comprised of an insulating layer, a light-emitting layer, and an insulating layer, or an electron barrier layer, a light-emitting layer, and a current limiting layer, arranged in this order from the transparent conductive film side may be used.

Moreover, in the present embodiment, an organic EL device 100 is used as the EL display panel. However, there is no limitation thereto, but rather a display panel such as a CRT or a PDP may be used.

### INDUSTRIAL APPLICABILITY

According to the display panel of the present invention, a substrate and a sealing plate are sealed together via a welded layer comprised of a metallic material. As a result, the display panel can be prevented from being exposed to a high temperature during manufacture, and moreover the gas-tightness of a recessed portion of the sealing plate can be improved and the moisture permeability of the recessed portion can be reduced, and hence the weather resistance of the display panel can be improved.

According to the display panel of the present invention, the solder further contains at least one material selected from the group consisting of Ti, Al, and Cr. As a result, the adhesion between the welded layer and glass components of the substrate can be improved.

According to the display panel of the present invention, the metallic material has a eutectic point or melting point of not more than 250° C. As a result, deterioration of the display panel through heat during welding, and warping of the substrate through heat can be reliably prevented.

According to the display panel of the present invention, the solder is substantially comprised of In and Sn, and has a liquidus temperature of not more than 150° C. As a result, the adhesion to the substrate can be further improved, and moreover the sealing can be accomplished at a low temperature.

According to the display panel of the present invention, the solder is substantially comprised of In and Sn, has an In/(In+Sn) weight distribution ratio in a range of 50 to 65%, and has a liquidus temperature of not more than 125° C. As a result, the adhesion to the substrate can be further improved, and furthermore the structure after solidification is fine and highly flexible, and the mechanical properties are excellent, and moreover the sealing can be accomplished at a yet lower temperature.

According to the display panel of the present invention, the solder is substantially comprised of In, Sn, Zn and Ti, has an In/(In+Sn) weight distribution ratio in a range of 50 to 65%, has a Zn content in a range of 0.1 to 7.0%, has a Ti content in a range of 0.0001 to 0.1%, and has a liquidus temperature of not more than 150° C. As a result, the adhesion to the substrate can be further improved, and the Ti can be contained more homogeneously due to making both Ti and Zn be present, and hence the weather resistance at the interface between the solder and the substrate can be improved.

According to the display panel of the present invention, the solder is substantially comprised of In, Sn, Zn and Ti, has an In/(In+Sn) weight distribution ratio in a range of 50 to 65%, has a Zn content in a range of 0.1 to 5.0%, has a Ti content in a range of 0.0001 to 0.05%, and has a liquidus temperature of not more than 125° C. As a result, the adhesion to the substrate can be further improved, and the Ti can be contained more homogeneously due to making both Ti and Zn be present, and hence the weather resistance at the interface between the solder and the substrate can be further improved.

According to the method of manufacturing a display panel of the present invention, a substrate and a sealing plate are sealed together through friction welding using a molten metallic material. As a result, the sealing can be accomplished with improved adhesion of the metallic material to the substrate.

According to the method of manufacturing a display panel of the present invention, a molten metallic material is applied onto at least one of an outer peripheral portion of one major surface of a substrate and an outer peripheral portion of one major surface of a sealing plate, the one major surface of the substrate and the one major surface of the sealing plate are placed together, and the applied metallic material is welded so as to seal the substrate and the sealing plate together. As a result, the metallic material can be applied to a desired width and thickness, and hence the weather resistance of the display panel can be further improved.

According to the method of manufacturing a display panel of the present invention, when applying the metallic material, an interface between the molten metallic material and the at least one of the outer peripheral portion of the one major surface of the substrate and the outer peripheral portion of the one major surface of the sealing plate is activated. As a result, the bonding strength between the substrate and the metallic material and the bonding strength between the sealing plate and the metallic material can be improved.

According to the method of manufacturing a display panel of the present invention, at least one of the application and the sealing is carried out in an inert atmosphere. As a result, production of an oxide on the surface of the metallic material can be suppressed.

1. A display panel comprising a substrate, and a sealing plate sealed onto said substrate, characterized in that said substrate and said sealing plate are sealed together via a welded layer comprising a metallic material.

2. A display panel as claimed in claim 1, characterized in that said metallic material comprises a solder containing at least one material selected from the group consisting of Sn, Cu, In, Bi, Zn, Pb, Sb, Ga, and Ag.

3. A display panel as claimed in claim 2, characterized in that said solder further contains at least one material selected from the group consisting of Ti, Al, and Cr.

4. A display panel as claimed in claim 1, characterized in that said metallic material has a eutectic point or melting point of not more than 250° C.

5. A display panel as claimed in claim 2, characterized in that said solder substantially comprises In and Sn, and has a liquidus temperature of not more than 150° C.

6. A display panel as claimed in claim 2, characterized in that said solder substantially comprises In and Sn, has an In/(In+Sn) weight distribution ratio in a range of 50 to 65%, and has a liquidus temperature of not more than 125° C.

7. A display panel as claimed in claim 3, characterized in that said solder substantially comprises In, Sn, Zn and Ti, has an In/(In+Sn) weight distribution ratio in a range of 50 to 65%, has a Zn content in a range of 0.1 to 7.0%, has a Ti content in a range of 0.0001 to 0.1%, and has a liquidus temperature of not more than 150° C.

8. A display panel as claimed in claim 3, characterized in that said solder substantially comprises In, Sn, Zn and Ti, has an In/(In+Sn) weight distribution ratio in a range of 50 to 65%, has a Zn content in a range of 0.1 to 5.0%, has a Ti content in a range of 0.0001 to 0.05%, and has a liquidus temperature of not more than 125° C.

9. A display panel as claimed in claim 1, characterized in that the display panel is an organic EL display panel.

10. A method of manufacturing a display panel comprising a substrate, and a sealing plate sealed onto the substrate, characterized by sealing together the substrate and the sealing plate through friction welding using a molten metallic material.

11. A method of manufacturing a display panel comprising a substrate, and a sealing plate sealed onto the substrate, characterized by comprising an application step of applying a molten metallic material onto at least one of an outer peripheral portion of one major surface of the substrate and an outer peripheral portion of one major surface of the sealing plate, a placing-together step of placing the one major surface of the substrate and the one major surface of the sealing plate together, and a sealing step of welding the applied metallic material so as to seal the substrate and the sealing plate together.

12. A method of manufacturing a display panel as claimed in claim 11, characterized in that in said application step, when applying the metallic material, an interface between the molten metallic material and the at least one of the outer peripheral portion of the one major surface of the substrate and the outer peripheral portion of the one major surface of the sealing plate is activated.

13. A method of manufacturing a display panel as claimed in claim 11, characterized in that at least one of said application step and said sealing step is carried out in an inert atmosphere.
